(19) United States
(12) Patent Application Publication
(10) Pub. No.: US 2026/0102875 A1
(43) Pub. Date: Apr. 16, 2026

(54) ELECTRIC WORK MACHINE

(71) Applicant: MAKITA CORPORATION, ANJO-SHI (JP)

(72) Inventor: Sho ENOMOTO, Anjo-shi (JP)

(21) Appl. No.: 19/319,817

(22) Filed: Sep. 5, 2025

(30) Foreign Application Priority Data
Oct. 10, 2024 (JP) 2024-177692

(51) Int. Cl. B24B 47/26; B24B 23/02; F04D 17/16; F04D 29/28; F04D 29/66; H02K 9/06

(52) U.S. Cl. CPC B24B 47/26; F04D 17/16; F04D 29/281; F04D 29/666; H02K 9/06; B24B 23/02

(57) ABSTRACT

A centrifugal fan for an electric work machine (1) includes a wall part (136), which radially surrounds a fan main body (5) that includes a blade unit (55) having radially-extending blades (56) on one surface of a disc (51). The wall part is defines a flow path, between an outer-circumferential edge (D1) of the blade unit and an inner surface of the wall part, that directs, in a first direction that is parallel to the first axis, air delivered radially outward from (by) the plurality of blades. The inner diameter (D2) of the blade unit is 45%-60% of the outer diameter (D1) of the blade unit. The outer diameter (D3) of the disc is 80%-95% of the outer diameter of the blade unit. The inner diameter (D4) of the wall part is 110%-120% of the outer diameter of the blade unit.

### CROSS-REFERENCE

The present application claims priority to Japanese patent application serial number 2024-177692 filed on Oct. 10, 2024, the contents of which are fully incorporated herein by reference.

### TECHNICAL FIELD

The present disclosure relates to a centrifugal fan and to an electric work machine, e.g., a power tool or outdoor power equipment, comprising the centrifugal fan.

### BACKGROUND ART

Many known electric work machines comprise a motor and a centrifugal fan, which is rotated by the motor to generate an airflow. The airflow generated by the centrifugal fan is used, for example, to cool an internal mechanism (e.g., a motor) and/or to collect, suction or otherwise move dust, debris, etc. For example, a grinder comprising a centrifugal fan for cooling a motor is disclosed in US Patent Publication 2023/0278157 (A1).

### SUMMARY OF THE INVENTION

In electric work machines, it is desirable to reduce the noise that accompanies the rotation of a centrifugal fan. Nevertheless, there is a possibility that reducing noise will lead to a reduced airflow. It is therefore one non-limiting object of the present teachings to disclose techniques for reducing or limiting noise produced by the centrifugal fan while still ensuring sufficient airflow for the intended application of the electric work machine.

In a first non-limiting aspect of the present disclosure, a centrifugal fan for an electric work machine comprises a fan main body and a wall part, which is disposed around (radially surrounds) the fan main body. The fan main body comprises a disc, which is centered about a first axis, and a blade unit, which comprises a plurality of blades. The blades are each arranged on one surface of the disc and extend radially outwardly from a central portion of the blade unit. Each blade extends radially outward of (beyond) an outer-circumferential edge (outer circumference) of the disc. In other words, the radially outermost end of each of the blades extends radially outward of (beyond) the outer-circumferential edge of the disc. The wall part is configured to define a flow path, between an outer-circumferential edge of the blade unit and an inner surface of the wall part, that directs, in a first direction that is parallel to the first axis, air delivered (forced, moved) radially outward from (by) the plurality of blades as the blade unit rotates.

The inner diameter of the blade unit is in the range of 45%-60% of the outer diameter of the blade unit. The outer diameter of the disc is in the range of 80%-95% of the outer diameter of the blade unit. The inner diameter of the wall part is in the range of 110%-120% of the outer diameter of the blade unit.

According to the first aspect, a centrifugal fan is provided with which noise can be restrained while still ensuring sufficient airflow. In other words, as compared to previously known centrifugal fans, the same airflow can be provided with less noise and/or a greater airflow can be provided at the same noise level.

In a second, non-limiting aspect of the present disclosure, an electric work machine comprises a housing, a motor, a centrifugal fan, and a wall part. It is noted that, in the present disclosure, the term “electric work machine” generally refers to machines and tools that are configured to use electricity as a power source to perform work. Non-limiting examples of electric work machines according to the present teachings include, but are not limited to, power tools designed to perform processing work on wood materials, metals, concrete, or the like, dust collectors (vacuums, dust extractors) that optionally may be used together with a power tool, cleaning machines, and gardening tools (outdoor power equipment).

The housing has one or more air-intake ports and one or more air-exhaust ports. The motor is disposed inside the housing. The centrifugal fan is disposed inside the housing. The centrifugal fan is configured to generate a flow of air from the air-intake port(s) to the air-exhaust port(s) inside the housing when rotated by the motor about a first axis. The wall part is disposed around (radially surrounds) the centrifugal fan. The centrifugal fan comprises a disc, which is centered about the first axis, and a blade unit, which comprises a plurality of blades. The blade are each arranged on one surface of the disc and extend radially outwardly from a central portion of the blade unit. Each blade extends radially outward of (beyond) an outer-circumferential edge (outer circumference) of the disc. In other words, the radially outermost end of each of the blades extends radially of (beyond) the outer-circumferential edge of the disc. The wall part is configured to define a flow path, between an outer-circumferential edge of the plurality of blades and the inner surface of the wall part, that directs, in a first direction that is parallel to the first axis, air delivered (forced, moved) radially outward from (by) the plurality of blades as the blade unit rotates.

The inner diameter of the blade unit is in the range of 45%-60% of the outer diameter of the blade unit. The outer diameter of the disc is in the range of 80%-95% of the outer diameter of the blade unit. The inner diameter of the wall part is in the range of 110%-120% of the outer diameter of the blade unit.

According to the second aspect, an electric work machine is provided that comprises a centrifugal fan with which noise can be restrained while still ensuring sufficient airflow. In other words, as compared to previously known electric work machines, the same airflow can be provided with less noise and/or a greater airflow can be provided at the same noise level.

### BRIEF DESCRIPTION OF THE DRAWINGS

FIG. 1 is an oblique view of a grinder according to one non-limiting embodiment of the present teachings.

FIG. 2 is a cross-sectional view of the grinder.

FIG. 3 is a rear view of a centrifugal fan.

FIG. 4 is a cross-sectional view taken along line IV-IV in FIG. 3.

FIG. 5 is a partial, enlarged view of FIG. 2.

FIG. 6 is a cross-sectional view taken along line VI-VI in FIG. 2.

FIG. 7 is a table showing numerical values pertaining to four factors of the centrifugal fans of Working Examples 1-5 and Comparative Examples 1-3.

FIG. 8 is a schematic drawing for explaining a testing apparatus used for measuring airflow and noise.

FIG. 9 is an airflow-noise-level scatter graph illustrating the correlation between the airflow and the noise level of the centrifugal fans of Working Examples 1-5 and Comparative Examples 1-3.

### DETAILED DESCRIPTION OF THE INVENTION

It is preferable that the number of blades in the blade unit is in the range of 35 to 50 in one or more embodiments of the present disclosure.

In addition or in the alternative, at least a portion of the wall part may be formed (defined) by a portion of the housing of the electric work machine. According to this embodiment, the part count can be reduced as compared with a configuration in which the wall part is provided separately from the housing.

In addition or in the alternative, the electric work machine may be a grinder. The motor and the centrifugal fan may be disposed between the air-intake port(s) and the air-exhaust port(s) in the first direction within the housing. The centrifugal fan may be configured to generate a flow of air for cooling the motor. According to this embodiment, the motor for the grinder can be effectively cooled by the centrifugal fan.

A grinder 1 comprising a centrifugal fan 5 (simply called the “fan 5” below) according to one representative and non-limiting embodiment of the present disclosure will be described in greater detail below with reference to the drawings.

This detailed explanation is intended merely to disclose to a person skilled in the art the details of preferred examples for implementing the present disclosure and is not intended to limit the scope of the present disclosure. Accordingly, all combinations of the features exemplified by the embodiment are not necessarily essential to the solutions for addressing the problems described in the present disclosure. The various features disclosed in the above-mentioned or below-mentioned embodiments, and the various features set forth in the independent and dependent claims do not necessarily have to be combined as indicated in the concrete examples recited herein to provide supplemental, useful embodiments of the present disclosure.

In addition, the various features disclosed in the above-mentioned or below-mentioned embodiments and the various features set forth in the independent and dependent claims are intended to be disclosed individually and mutually independently as limitations relative to the disclosure and the specific subject matters claimed in the original patent application. Furthermore, descriptions relating to all numerical ranges are intended to disclose intermediate configurations thereof as limitations relative to the disclosure and the specific matters claimed in the original patent application.

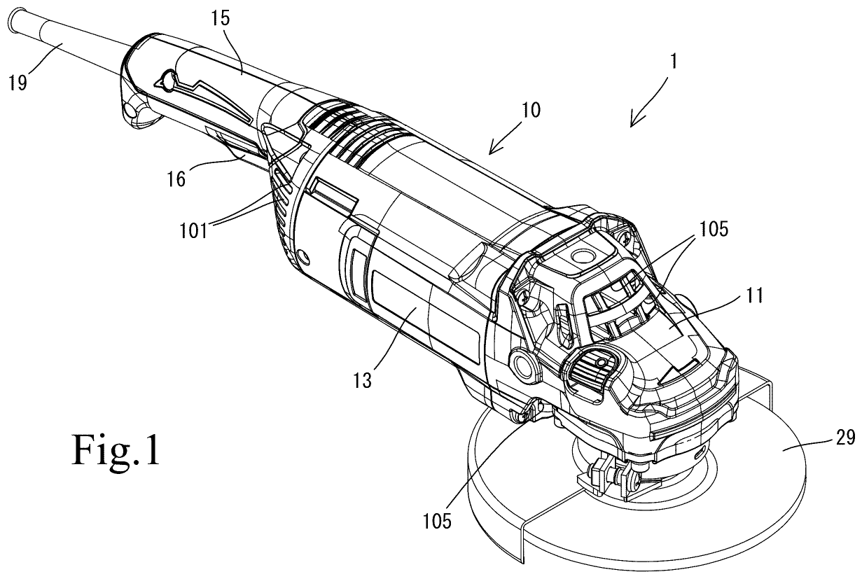

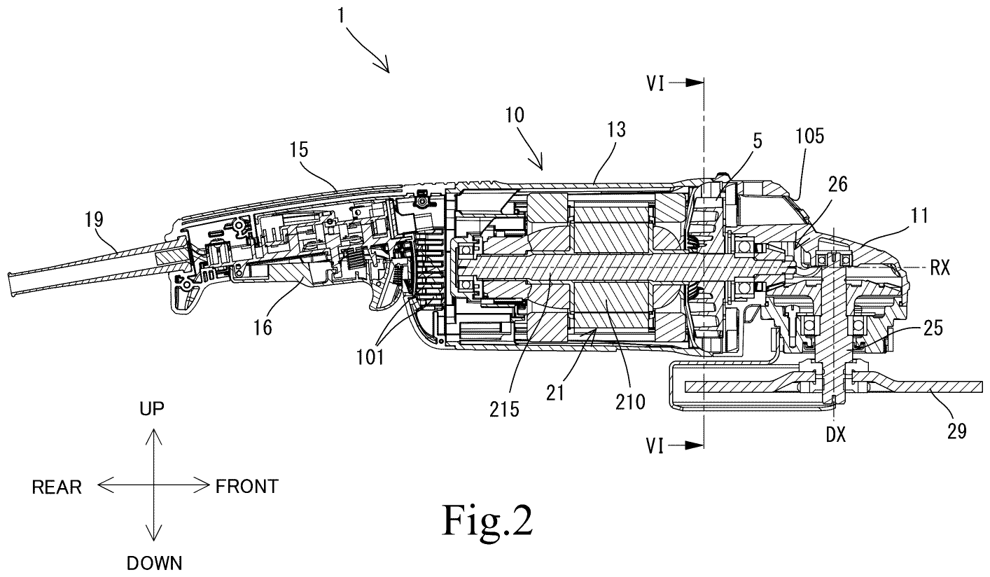

First, the general configuration of the grinder 1 will be described with reference to FIG. 1 and FIG. 2. The grinder 1 is one example of an electric work machine according to the present teachings. In greater detail, the grinder 1, which also may be called a disc grinder or an angle grinder, is one example of a portable power tool according to the present teachings. The grinder 1 is configured to perform various processing tasks (e.g., grinding, abrading, or cutting) by rotating a tool accessory 29 having a disc shape.

The grinder 1 comprises a housing 10, a motor 21, the fan 5, and a spindle 25.

The housing 10 is a hollow body, which may also be called a tool main body, having an elongated shape, which forms the outer wall of the grinder 1. The motor 21, the fan 5, and the spindle 25 are housed in the housing 10. The motor 21 is disposed such that rotational axis RX of an output shaft 215 of the motor 21 extends at least substantially parallel (preferably parallel) to a longitudinal axis of the housing 10. The fan 5 is fixed to the output shaft 215 so as to rotate therewith. The spindle 25 is operably coupled to the motor 21 and is supported within one end portion of the housing 10 in a longitudinal-axis direction so as to be rotatable about drive axis DX. Drive axis DX extends in a direction that intersects (specifically, is at least substantially orthogonal, preferably orthogonal, to) rotational axis RX of the output shaft 215. One end portion of the spindle 25 in the axial direction thereof is exposed from the housing 10 to the outside and is configured to serve as a tool-mounting part. The tool accessory 29 is mounted on the tool-mounting part of the spindle 25 in a detachable manner.

It is noted that, for the sake of convenience in the explanation below, the extension direction of drive axis DX is defined as the up-down direction of the grinder 1. In the up-down direction, the side on which the tool-mounting part of the spindle 25 is located is defined as the lower side of the grinder 1, and the opposite side is defined as the upper side of the grinder 1. The longitudinal-axis direction of the housing 10 (i.e., the extension direction of rotational axis RX of the motor 21) is defined as a front-rear direction of the grinder 1. In the front-rear direction, the side on which the spindle 25 is located is defined as a front side of the grinder 1, and the opposite side is defined as a rear side of the grinder 1. A direction that is orthogonal to the up-down direction and the front-rear direction is defined as a left-right direction of the grinder 1.

Further details concerning the configuration of the grinder 1 will be described below.

As shown in FIG. 1 and FIG. 2, the housing 10 comprises, from the front side in order: a head part 11 (also called a gear housing); a motor-housing part 13 (also called a motor housing); and a main handle 15.

The head part 11 houses the spindle 25 and a speed-reduction gear train (e.g., a bevel gear mechanism) 26. The speed-reduction gear train 26 operably couples the output shaft 215 of the motor 21 to the spindle 25 and thus transmits the rotational energy of the output shaft 215 to the spindle 25.

The motor-housing part 13 has an elongated, tubular shape and houses the motor 21 and the fan 5. The motor 21 comprises: a motor-main-body part 210, which comprises a stator and a rotor; and the output shaft 215, which is configured to rotate integrally with the rotor. A front-end portion of the output shaft 215 protrudes into the interior of the head part 11 and is operably coupled to the spindle 25 via the speed-reduction gear train 26. The fan 5 is disposed inside a front-end portion of the motor-housing part 13. The fan 5 is fixed to the output shaft 215 at the front side of the motor-main-body part 210 and rotates integrally with the output shaft 215. It is noted that the configuration of the fan 5 and peripheral portions thereof are described in greater detail below.

The main handle 15 is configured to be gripped by a user and has a tubular shape, the diameter of which is smaller than the diameter of the motor-housing part 13. A trigger switch 16 (also called a switch lever) for manually controlling operation of the grinder 1 is provided on the main handle 15. A power-supply cord 19, which is connectable to an external power supply, extends from the rear end of the housing 10, and the grinder 1 is driven with electric power supplied from the external power supply. However, in a different embodiment, the grinder 1 may be driven with electric power supplied from a battery (rechargeable battery pack or battery cartridge) instead of from an external power supply. In addition, in another embodiment, the motor-housing part 13 of the housing 10 may also function as a main handle.

The housing 10 of the present embodiment has air-intake ports 101, which permit air to flow into the interior of the housing 10, and air-exhaust ports 105, which permit air to be exhausted to the exterior of the housing 10. In the present embodiment, the air-intake ports 101 are formed in a rear-end portion (in greater detail, in a right-side portion and a left-side portion of the rear-end portion) of the motor-housing part 13. The air-exhaust ports 105 are formed in an upper portion and a lower portion of the head part 11. The motor 21 (the motor-main-body part 210) and the fan 5 are disposed between the air-intake ports 101 and the air-exhaust ports 105 in the front-rear direction.

When the user presses the trigger switch 16, the motor 21 is driven, and the spindle 25 is rotationally driven about drive axis DX by the motive power of the motor 21.

The tool accessory 29, which is mounted on the spindle 25, is rotated as the spindle 25 rotates, and thereby processing work (e.g., grinding, abrading, cutting, polishing, etc.) can be performed on a workpiece. In addition, rotation of the fan 5 generates a flow of air that is suctioned into the interior of the housing 10 through the air-intake ports 101, flows forward inside the housing 10, and is discharged to the outside via the air-exhaust ports 105. This flow of air cools the motor 21 by passing around and through the interior of the motor-main-body part 210.

The configuration of the fan 5 and peripheral portions of the fan 5 will now be described in greater detail.

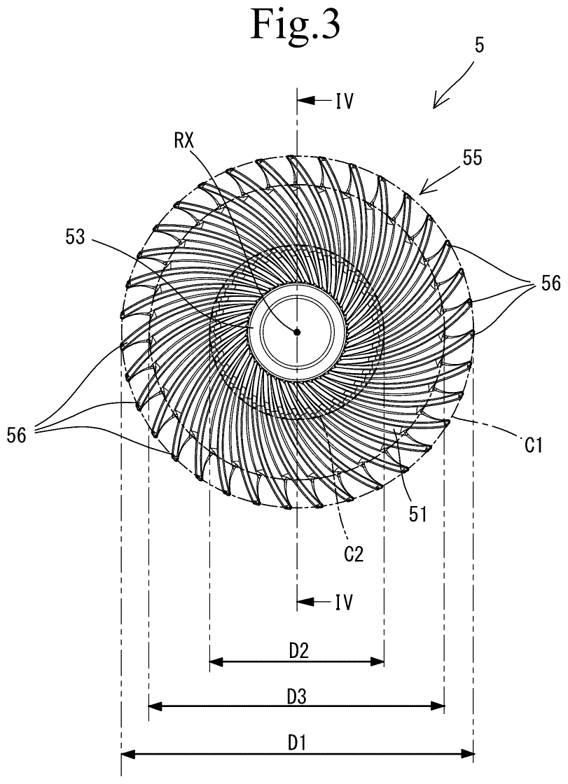

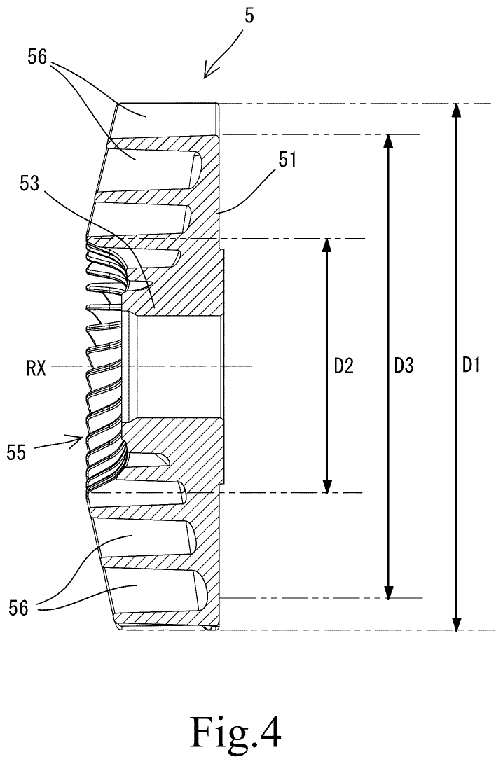

As shown in FIG. 3 and FIG. 4, the fan 5 according to the present embodiment is a so-called open-type impeller and comprises a disc 51, a hub 53, and a blade unit 55, which are disposed coaxially. In the present embodiment, the fan 5 is a singular component manufactured by integrally molding a polymer (synthetic resin). Nevertheless, in another embodiment, the fan 5 may be formed by coupling a plurality of components that are manufactured separately. In addition, in another embodiment, the fan 5 may be made of metal or may be made of both metal and polymer by insert molding (e.g., the disc 51 and hub 53 may be made of metal for structural robustness and the blades 56 may be made of plastic to reduce weight).

The disc 51 is a disc-shaped (round, circular) part and may also be called a main plate, a back plate, or the like. A hole is formed in the center of the disc 51. The hub 53 is a circular-tube-shaped portion, which is fitted (preferable force fit or friction fit) onto and thereby fixed to the output shaft 215 of the motor 21. The hub 53 is disposed around the hole in the disc 51 and protrudes from one surface of the disc 51 in the axial direction of the fan 5 (i.e., the extension direction of rotational axis RX). It is noted that, because the fan 5 is mounted coaxially with the output shaft 215, the (rotational) axis of the fan 5 mentioned in the explanation below may also be understood to be rotational axis RX of the output shaft 215.

The blade unit 55 comprises a plurality of blades 56. The blades 56 are arranged on one surface (i.e., the surface on which the hub 53 is disposed) of the disc 51 and protrude in the axial direction of the fan 5. The blades 56 extend radially outward from a central portion of the blade unit 55. In the present embodiment, all the blades 56 have the same shape and are disposed at a substantially uniform pitch in the circumferential direction of the disc 51.

In greater detail, each of the blades 56 extends radially outward from a prescribed location of the disc 51 in the radial direction. It is noted that the “blades 56 extend radially outward” may also be rephrased as the “blades 56 extend away from the center (rotational axis RX) of the disc 51.” In the present embodiment, the radially inward ends (simply the “inner ends” below) of the blades 56 are located at radial positions that are the same as the radial position of the outer-circumferential surface of the hub 53; however, the inner ends of the blades 56 may be at locations that differ from this example.

The blades 56 may extend in a straight-line shape along the radius of the disc 51 or may extend away from the center of the disc 51 while curving. In addition, the blades 56 may be tilted in any direction relative to the radius of the disc 51. In the fan 5 illustrated in the drawings, the blades 56 are so-called rear-facing blades, which are tilted in a reverse direction to the rotational direction (the clockwise direction in FIG. 3) of the fan 5, and extend radially outward while curving.

All the radially outward (outermost) ends (simply called the “outer ends” below) of the blades 56 are located along the circumference of circle C1, which is centered on the axis (rotational axis RX) of the fan 5; the diameter of circle C1 defines outer diameter D1 of the blade unit 55 (simply called “blade outer diameter D1” below). In the present embodiment, each of the blades 56 extends radially outward of (beyond) an outer-circumferential edge of the disc 51. That is, blade outer diameter D1 is larger than outer diameter D3 of the disc 51 (simply called “disc outer diameter D3” below).

The height of each of the blades 56 in the axial direction of the fan 5 increases from the inner end of the blade 56 as it extends radially outward along the blade. The height of each of the blades 56 is at a maximum at a prescribed location in the radial direction and decreases from this prescribed location as it extends toward the outer end of the blade 56. More specifically, the location at which the height of the blade 56 is a maximum may preferably be along the circumference of circle C2, which is centered about the axis of the fan 5 and has a diameter that is smaller than blade outer diameter D1 and disc outer diameter D3. The diameter of circle C2 defines inner diameter D2 of the blade unit 55 (simply called “blade inner diameter D2” below). It is noted that the height of each of the blades 56 does not necessarily need to vary as the blades 56 extend radially outward. For example, the height of each of the blades 56 may be uniform (constant) from the inner end to the outer end. Alternatively, the height of each of the blades 56 may increase from the inner end to a prescribed location in the radial direction and then may be uniform (constant) from this location to the outer end.

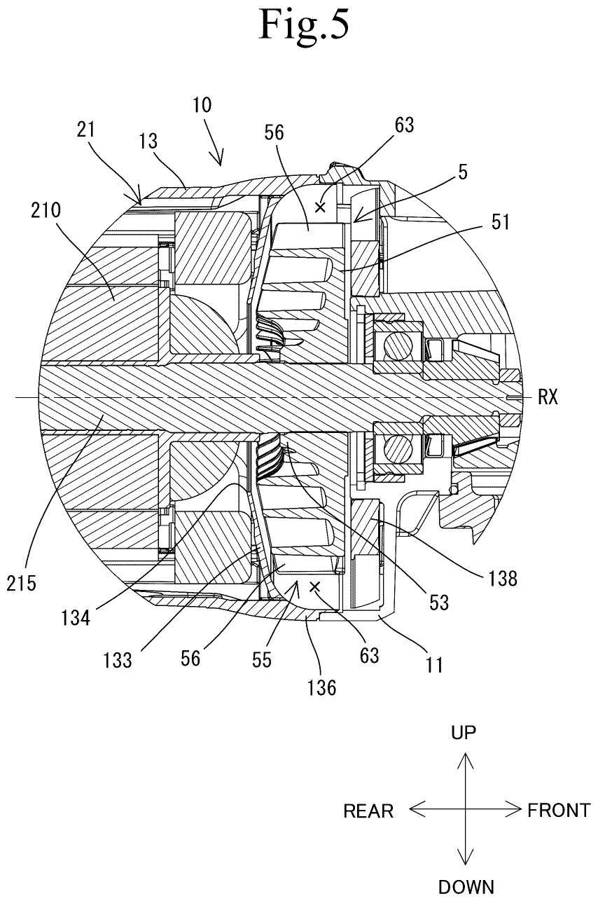

As shown in FIG. 5, the fan 5, which has the configuration described above, is fixed to the output shaft 215 such that the surface of the disc 51 on which the blade unit 55 is disposed is oriented (faces) rearward (i.e., such that protruding ends of the blades 56 oppose (face) the motor-main-body part 210). A guide plate 133 is disposed between the fan 5 and the motor-main-body part 210 in the front-rear direction to enable the fan 5 to more efficiently suction air. A circular-shaped suction port 134, which has substantially the same or a slightly larger diameter than blade inner diameter D2, is formed at the center of the guide plate 133. Accordingly, as the fan 5 rotates, air is suctioned in by the fan 5 in the axial direction (forward) through the suction port 134, flows radially outward through flow paths defined between adjacent blades 56, and flows out from openings between the outer ends of the adjacent blades 56. The flow paths between the blades 56 are also called “internal flow paths” below.

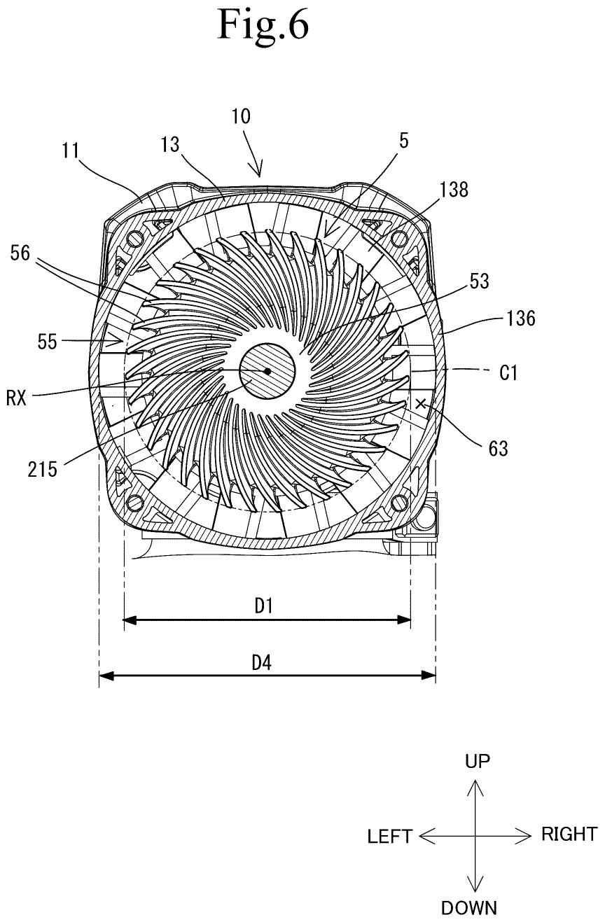

Inside the motor-housing part 13, a flow path that directs, in the axial direction (i.e., forward), the air, which has been delivered from (supplied via) the internal flow paths, is defined around the blade unit 55 of the fan 5. The flow path around the blade unit 55 is also called “external flow path 63” below. As shown in FIG. 5 and FIG. 6, in the present embodiment, a tube-wall part 136, which is the portion of the motor-housing part 13 that is disposed around the blade unit 55, has an at least substantially circular-shaped cross section and is disposed coaxially with the fan 5. Accordingly, inner diameter D4 of the tube-wall part 136 (simply called “tube inner diameter D4” below) is larger than blade outer diameter D1. Owing to this tube-wall part 136, the external flow path 63 is defined between the outer-circumferential edge of the blade unit 55 and an inner surface of the tube-wall part 136. That is, tube inner diameter D4 can also be called the outer diameter of the external flow path 63. It is noted that the outer-circumferential edge of the blade unit 55 is defined by the outer ends of the blades 56.

A partition 138, which partitions an interior space of the motor-housing part 13 and an interior space of the head part 11, is disposed at the front side of the tube-wall part 136. A communication opening is provided in the partition 138, and the air delivered by the fan 5 flows forward through the external flow path 63, passes through the communication opening in the partition 138, and flows into the upper portion and the lower portion of the head part 11, after which the air is discharged to the outside through the air-exhaust ports 105 (see FIG. 1).

Furthermore, from among the numerous factors used to determine the specifications of a centrifugal fan, the fan 5 of the present embodiment has characteristics pertaining to specific factors that are not present in previously-existing centrifugal fans.

For example, factors, such as the outer diameter of the fan, the shape of the blades, the height of an inlet, an entrance angle, an exit angle, the number of blades, and the like are generally known as factors used to determine the specifications of a centrifugal fan. However, identifying a combination of specific factors that significantly impact the airflow and the noise of the centrifugal fan from among these numerous factors, and suitably setting numerical ranges therefor, is not an easy task. The inventors of the present application performed various tests by changing various factors and developed embodiments of the present invention based on the test results. More specifically, it was determined that airflow can be increased while reducing noise by suitably setting the numerical ranges for at least two factors among the following four factors, namely: (i) blade inner diameter D2; (ii) disc outer diameter D3; (iii) tube inner diameter D4; and (iv) number of blades 56 (simply called “blade count B” below).

Furthermore, it was found to be particularly effective when the ratios (percentages) of the above-mentioned factors (i), (ii) and (iii) to blade outer diameter D1 satisfy the following conditions (a)-(c). It is noted that all instances of a “range of XX-YY” in the description below are intended to include XX as the lower-limit value and YY as the upper-limit value. In other words, the expression “range of XX-YY” means “XX or greater and YY or less”.
(a) Blade inner diameter D2 is in the range of 45%-60% of blade outer diameter D1. In other words, the ratio (percentage) of blade inner diameter D2 to blade outer diameter D1 (also simply called the “blade inner-diameter ratio” below) is in the range of 0.45-0.60 (0.45≤D2/D1≤0.60).
(b) Disc outer diameter D3 is in the range of 80%-95% of blade outer diameter D1. In other words, the ratio (percentage) of disc outer diameter D3 to blade outer diameter D1 (also simply called the “disc outer-diameter ratio” below) is in the range of 0.80-0.95 (0.80≤D3/D1≤0.95).
(c) Tube inner diameter D4 is in the range of 110%-120% of blade outer diameter D1. In other words, the ratio (percentage) of tube inner diameter D4 to blade outer diameter D1 (also simply called the “tube inner-diameter ratio” below) is in the range of 1.10-1.20 (1.10≤D4/D1≤1.20).

Furthermore, in addition to the above-mentioned conditions (a)-(c), it was confirmed to be even more effective to have (iv) blade count B, which is the fourth factor, satisfy the following condition (d). However, the following range is a preferred range because setting the blade count B to within the following range becomes difficult if blade inner diameter D2 becomes too small to accommodate the preferred number of blades 56.
(d) Blade count B is in the range of 35-50 (35≤B≤50).

The effects of the fan 5 according to the present embodiment will be described below with reference to the results of measuring the airflow and the noise in fans 5A-5E according to Working Examples 1-5 and fans 6A-6C according to Comparative Examples 1-3.

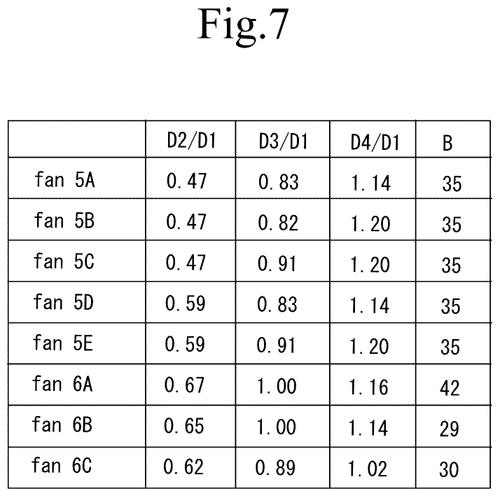

FIG. 7 shows the numerical values pertaining to the four factors for each of the fans 5A-5E according to Working Examples 1-5 and the fans 6A-6C according to Comparative Examples 1-3. It is noted that blade outer diameter D1 is 85 millimeters (mm) for all Working Examples 1-5 and Comparative Examples 1-3.

Each of the fans 5A-5E satisfies all the above-mentioned conditions (a)-(c) pertaining to the above-mentioned three factors (i)-(iii). Moreover, each of the fans 5A-5E also satisfies the above-mentioned condition (d) pertaining to factor (iv). In contrast, each of the fans 6A-6C fails to meet at least one of the conditions (a)-(c) pertaining to the above-mentioned three factors (i)-(iii). In addition, only the fan 6A satisfies the above-mentioned condition (d) pertaining to factor (iv).

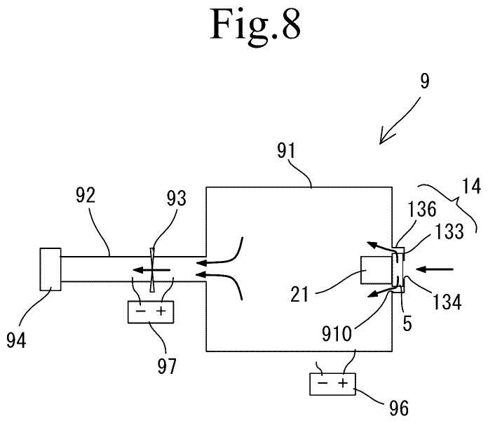

It is noted that all the fans 5A-5E, 6A-6C are the same in that they each include the disc 51, the hub 53, and the blade unit 55 (the plurality of blades 56), similar to the fan 5 described above. In contrast, in terms of measuring the airflow and the noise, the tube-wall part 136 that was employed was not the portion of the housing 10 described above but was instead a casing 14 (see FIG. 8), which was integrally formed with the guide plate 133.

In more detail, as depicted in FIG. 7, the blade inner-diameter ratio (D2/D1) of the fan 5A according to Working Example 1 was 0.47, the disc outer-diameter ratio (D3/D1) of the fan 5A according to Working Example 1 was 0.83, and the tube inner-diameter ratio (D4/D1) of the fan 5A according to Working Example 1 was 1.14. Blade count B of the fan 5A was 35. The blade inner-diameter ratio of the fan 5B according to Working Example 2 was 0.47, the disc outer-diameter ratio of the fan 5B according to Working Example 2 was 0.82, and the tube inner-diameter ratio of the fan 5B according to Working Example 2 was 1.20. Blade count B of the fan 5B was 35. The blade inner-diameter ratio of the fan 5C according to Working Example 3 was 0.47, the disc outer-diameter ratio of the fan 5C according to Working Example 3 was 0.91, and the tube inner-diameter ratio of the fan 5C according to Working Example 3 was 1.20. Blade count B of the fan 5C was 35. The blade inner-diameter ratio of the fan 5D according to Working Example 4 was 0.59, the disc outer-diameter ratio of the fan 5D according to Working Example 4 was 0.83, and the tube inner-diameter ratio of the fan 5D according to Working Example 4 was 1.14. Blade count B of the fan 5D was 35. The blade inner-diameter ratio of the fan 5E according to Working Example 5 was 0.59, the disc outer-diameter ratio of the fan 5E according to Working Example 5 was 0.91, and the tube inner-diameter ratio of the fan 5E according to Working Example 5 was 1.20. Blade count B of the fan 5E was 35.

In contrast, the blade inner-diameter ratio of the fan 6A according to Comparative Example 1 was 0.67, the disc outer-diameter ratio of the fan 6A according to Comparative Example 1 was 1.00, and the tube inner-diameter ratio of the fan 6A according to Comparative Example 1 was 1.16. Blade count B of the fan 6A was 42. The blade inner-diameter ratio of the fan 6B according to Comparative Example 2 was 0.65, the disc outer-diameter ratio of the fan 6B according to Comparative Example 2 was 1.00, and the tube inner-diameter ratio of the fan 6B according to Comparative Example 2 was 1.14. Blade count B of the fan 6B was 29. The blade inner-diameter ratio of the fan 6C according to Comparative Example 3 was 0.62, the disc outer-diameter ratio of the fan 6C according to Comparative Example 3 was 0.89, and the tube inner-diameter ratio of the fan 6C according to Comparative Example 3 was 1.02. Blade count B of the fan 6C was 30.

Suitable methods for measuring airflow and for measuring noise are each as described below.

The testing apparatus 9 shown in FIG. 8 was used for measuring the airflow. The testing apparatus 9 is equipped with an air vessel 91, a measurement conduit 92, an orifice plate 93, an auxiliary fan 94, and differential-pressure gauges 96, 97. It is noted that the testing apparatus used in the “method of testing and inspecting a fan” in JIS (Japan Industrial Standard) B8330:2000 for “the case of a fan in which both a discharge pipe and a suction pipe are not provided in the usage state” was referenced for this testing apparatus 9.

An opening 910 is provided in the air vessel 91 and is covered by the casing 14. The tube-wall part 136 of the casing 14 is mounted on the exterior of the air vessel 91 such that air does not leak from between the opening 910 and the tube-wall part 136. The measurement conduit 92 fluidly communicates with the air vessel 91, and the orifice plate 93 is provided in the measurement conduit 92. The auxiliary fan 94 is disposed at the terminal end of the measurement conduit 92. The differential-pressure gauge 96 is disposed so as to measure the pressure in the interior of the air vessel 91. The differential-pressure gauge 97 is disposed so as to measure the pressure differential at an upstream side and a downstream side of the orifice plate 93.

The motor 21, to which the fans 5A-5E, 6A-6C were each attached in turn, was installed in the air vessel 91, and was driven at the same rotational speed for each airflow measurement. More specifically, in the tests of the present embodiments, the rotational speed of the motor 21 was 18,000 rotations per minute (18,000 rpm) for all airflow measurements. Measurement values were acquired from each of the differential-pressure gauges 96, 97 at an arbitrary operating point (a flow path resistance) while adjusting the rotational speed of the auxiliary fan 94, and the airflow corresponding to each of the fans 5A-5E, 6A-6C was computed.

An apparatus, which utilized a portion of the testing apparatus 9, was employed in the measurement of noise. Specifically, in order to eliminate the influence of operating noise of the auxiliary fan 94, the components (namely, a downstream portion of the measurement conduit 92 and the auxiliary fan 94) that are downstream of the orifice plate 93 of the measurement conduit 92 in the testing apparatus 9 shown in FIG. 8 were removed. Furthermore, the air vessel 91 was disposed at the center of a semi-anechoic chamber in the state in which a sound-absorbing material for attenuating resonance lined the interior (walls and ceiling, but not the floor) of the semi-anechoic chamber. A noise-measurement microphone was disposed at a location 1 meter (m) away from the suction port 134 of the casing 14. The motor 21, to which the fans 5A-5E, 6A-6C were each attached in turn, was installed in the air vessel 91, and was driven at 18,000 rpm for each noise measurement. The open area of the terminal end of the measurement conduit 92 was adjusted so that the pressure in the interior of the air vessel 91 became substantially the same as the pressure during the airflow rate measurements described above. Noise was measured in this state using the microphone and taken as an evaluation value (the noise level corresponding to the airflow).

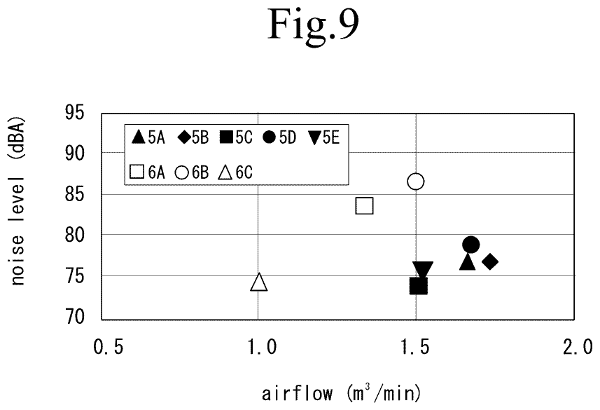

FIG. 9 shows the results in which the airflow and the noise level were measured according to the methods described above for each of the fans 5A-5E according to Working Examples 1-5 and the fans 6A-6C according to Comparative Examples 1-3.

The airflow of the fan 5A was 1.66 cubic meters per minute (m³/min), and the noise level was 77.0 A-weighted decibels (dBA). The airflow of the fan 5B was 1.73 m³/min, and the noise level was 77.0 dBA. The airflow of the fan 5C was 1.51 m³/min, and the noise level was 74.0 dBA. The airflow of the fan 5D was 1.67 m³/min, and the noise level was 78.9 dBA. The airflow of the fan 5E was 1.52 m³/min, and the noise level was 75.9 dBA.

The airflow of the fan 6A was 1.33 m³/min, and the noise level was 83.8 dBA. The airflow of the fan 6B was 1.50 m³/min, and the noise level was 86.7 dBA. The airflow of the fan 6C was 1.00 m³/min, and the noise level was 74.6 dBA.

From the airflow-noise-level scatter graph shown in FIG. 9, it can be derived that when the airflow and the noise level are considered comprehensively, all the fans 5A-5E are superior to the fans 6A-6C. Specifically, all the fans 5A-5E were able to exhibit an airflow of 1.5 m³/min or more under the measurement conditions described above and were able to restrain the noise level to 80 dBA or less. It is noted that, when comparing the fan 5C according to Working Example 3 and the fan 6C according to Comparative Example 3, while the noise levels were on the same order, the fan 5C provided significantly greater airflow. Accordingly, the fan 5C is superior overall. In addition, when comparing the fans 5C, 5E according to Working Examples 3, 5 and the fan 6B according to Comparative Example 2, while the airflows were on the same order, each of the fans 5C, 5E had a noise level that was significantly lower. Accordingly, the fans 5C, 5E are superior overall.

It is noted that, in the present embodiments, the measurement results under the conditions that blade outer diameter D1 was 85 mm for all fans 5 and the rotational speed of the motor 21 was 18,000 rpm in all measurements are shown by way of example. Nevertheless, as long as a fan is geometrically similar to the fans 5A-5E, 6A-6C described above, the correlation between the airflow and the noise level will exhibit the same trend as shown in FIG. 9, even in the situation in which blade outer diameter D1 and/or the rotational speed of the motor 21 has (have) been modified.

As explained above, it was confirmed that the fan 5 according to the present embodiment can retrain noise while ensuring sufficient airflow. In other words, for a particular airflow rate, less noise is generated as compared to fans that did not satisfy conditions (a)-(c) described above.

It is noted that not all four factors—(i) blade inner diameter D2; (ii) disc outer diameter D3; (iii) tube inner diameter D4; and (iv) blade count B—need to be satisfied; as long as at least two of the factors satisfy the corresponding condition among the four conditions (a)-(d) described above, the effect of increasing the airflow while reducing the noise can be obtained. Accordingly, (i) blade inner diameter D2 and (iii) tube inner diameter D4, for example, may each simply satisfy the corresponding conditions (a) and (c), respectively. Alternatively, for example, (ii) disc outer diameter D3, (iii) tube inner diameter D4, and (iv) blade count B may each simply satisfy the corresponding conditions (b), (c), and (d), respectively.

The correspondence relationships between the structural elements (features) of the above-mentioned embodiment and the structural elements (features) of the present disclosure are indicated below. However, the structural elements of the embodiment are each merely one example and do not limit the structural elements of the present disclosure.

The grinder 1 is one example of an “electric work machine” and a “grinder.” The fans 5, 5A-5E are each one example of a “centrifugal fan” and a “fan main body.” The disc 51 is one example of a “disc.” The blade unit 55 and the blades 56 are one example of the “blade unit” and the “blades,” respectively. The tube-wall part 136 is one example of the “wall part.” The housing 10 is one example of the “housing.” The air-intake ports 101 and the air-exhaust ports 105 are each one example of an “air-intake port” and an “air-exhaust port,” respectively. The motor 21 is one example of a “motor.”It is noted that the above-mentioned embodiment is merely an illustrative example, and centrifugal fans and electric work machines according to the present disclosure are not limited to the fan 5 (5A-5E) and the grinder 1 exemplified herein. For example, the non-limiting modifications described below are possible while remaining within the scope of the present teachings.

In addition to being adapted to the grinder 1, the centrifugal fan according to the present disclosure is also adaptable, for example, to an electric work machine configured such that the air delivered radially outward from the blade unit is directed by the wall part around the blade unit of the centrifugal fan in the axial direction. For example, power tools, dust collectors (dust extractors, vacuums) or cleaning machines that may be used alone or optionally together with power tools, and gardening tools (outdoor power equipment) are included within the scope of electric work machines according to the present teachings. Furthermore, e.g., circular saws, backpack-type upright vacuum cleaners, upright vacuum cleaners, robotic vacuum cleaners, and stick vacuum cleaners are further non-limiting, specific examples of electric work machines which may advantageously utilize the centrifugal fan of the present disclosure.

In addition, the wall part around the blade unit of the centrifugal fan does not necessarily need to be constituted by a portion of the housing of the electric work machine.

As with the casing 14 (see FIG. 8) that was employed in the testing described above, the flow path around the blade unit inside the housing may be defined by a structure (e.g., a tubular member) that is separate from the housing.

### EXPLANATION OF THE REFERENCE

1 Grinder
10 Housing
101 Air-intake port
105 Air-exhaust port
11 Head part
13 Motor-housing part
133 Guide plate
134 Suction port
136 Tube-wall part
138 Partition
14 Casing
15 Main handle
16 Trigger switch
19 Power-supply cord
21 Motor
210 Motor-main-body part
215 Output shaft
25 Spindle
26 Reduction gear train
29 Tool accessory
5, 5A, 5B, 5C, 5D, 5E, 6A, 6B, 6C Centrifugal fans (fans)
51 Disc
53 Hub
55 Blade unit
56 Blade
63 External flow path
9 Testing apparatus
91 Air vessel
92 Measurement conduit
93 Orifice plate
94 Auxiliary fan
96 Differential-pressure gauge
97 Differential-pressure gauge
910 Opening
DX Drive axis
RX Rotational axis

1. A centrifugal fan for an electric work machine, comprising:
a fan main body; and
a wall part, which radially surrounds the fan main body;
wherein:
the fan main body comprises:
a disc centered about a first axis; and
a blade unit, which comprises a plurality of blades arranged on one surface of the disc, each blade extending radially outward from a central portion of the blade unit to beyond an outer-circumferential edge of the disc;
the wall part is configured to define a flow path, between an outer-circumferential edge of the blade unit and an inner surface of the wall part, that directs, in a first direction that is parallel to the first axis, air delivered radially outward from the plurality of blades;
the inner diameter of the blade unit is in the range of 45%-60% of the outer diameter of the blade unit;
the outer diameter of the disc is in the range of 80%-95% of the outer diameter of the blade unit; and
the inner diameter of the wall part is in the range of 110%-120% of the outer diameter of the blade unit.

2. The centrifugal fan according to claim 1, wherein the number of blades of the blade unit is in the range of 35-50.

3. The centrifugal fan according to claim 2, wherein the blades extend radially outward from a hub of the blade unit.

4. The centrifugal fan according to claim 3, wherein the blades are straight and/or curved.

5. The centrifugal fan according to claim 1, wherein the blades extend radially outward from a hub of the blade unit.

6. The centrifugal fan according to claim 1, wherein the blades are straight and/or curved.

7. An electric work machine, comprising:
a housing, which has at least one air-intake port and at least one air-exhaust port;
a motor, which is disposed inside the housing;
a centrifugal fan, which is disposed inside the housing and is configured to generate a flow of air from the air-intake port(s) to the air-exhaust port(s) inside the housing when rotated by the motor around a first axis; and
a wall part, which is radially surrounds the centrifugal fan;
wherein:
the centrifugal fan comprises:
a disc centered about the first axis; and
a blade unit, which comprises a plurality of blades arranged on one surface of the disc, each blade extending radially outward from a central portion of the blade unit to beyond an outer-circumferential edge of the disc;
the wall part is configured to define a flow path, between an outer-circumferential edge of the plurality of blades and an inner surface of the wall part, that directs, in a first direction that is parallel to the first axis, air delivered radially outward from the plurality of blades;
the inner diameter of the blade unit is in the range of 45%-60% of the outer diameter of the blade unit;
the outer diameter of the disc is in the range of 80%-95% of the outer diameter of the blade unit; and
the inner diameter of the wall part is in the range of 110%-120% of the outer diameter of the blade unit.

8. The electric work machine according to claim 7, wherein the number of blades of the blade unit is in the range of 35-50.

9. The electric work machine according to claim 8, wherein at least a portion of the wall part is formed by a portion of the housing.

10. An electric work machine according to claim 9, wherein:
the electric work machine is a grinder;
the motor and the centrifugal fan are disposed between the air-intake port(s) and the air-exhaust(s) port in the first direction inside the housing; and
the centrifugal fan is configured to generate a flow of air for cooling the motor.

11. The electric work machine according to claim 10, wherein the blades extend radially outward from a hub of the blade unit.

12. The electric work machine according to claim 11, wherein the blades are straight and/or curved.

13. The electric work machine according to claim 7, wherein at least a portion of the wall part is formed by a portion of the housing.

14. An electric work machine according to claim 7, wherein:
the electric work machine is a grinder;
the motor and the centrifugal fan are disposed between the air-intake port(s) and the air-exhaust(s) port in the first direction inside the housing; and
the centrifugal fan is configured to generate a flow of air for cooling the motor.

15. The electric work machine according to claim 7, wherein the blades extend radially outward from a hub of the blade unit.

16. The electric work machine according to claim 7, wherein the blades are straight and/or curved.
